(19) United States
(12) Patent Application Publication
(10) Pub. No.: US 2024/0263510 A1
(43) Pub. Date: Aug. 8, 2024

(54) SQUARE WINDOW EXTRUSION AND DUAL SHADE/SCREEN ENCASEMENT

(71) Applicant: Lippert Components, Inc., Elkhart, IN (US)

(72) Inventors: Toby CROWLEY, Syracuse, IN (US); Patrick CLARK, Bristol, IN (US); Phats XAYAMATH, Granger, IN (US); Cesar AGUILERA, El Paso, TX (US)

(21) Appl. No.: 18/436,274

(22) Filed: Feb. 8, 2024

Related U.S. Application Data
(60) Provisional application No. 63/444,103, filed on Feb. 8, 2023.

(51) Int. Cl. E06B 3/26; B60J 1/00; B60J 1/20; E06B 3/96; E06B 9/262; E06B 9/52

(52) U.S. Cl. CPC E06B 3/26; E06B 3/9636; E06B 9/262; E06B 9/522; B60J 1/007; B60J 1/2011; E06B 2009/2625

(57) ABSTRACT

A square window is constructed from four aluminum portions that accommodate a shade assembly, securement of a glass pane, and a hook for installation. The square window frame accommodates more window covering options and is easier to install without requiring radiuses or curves to be cut in the vehicle wall.

### CROSS-REFERENCES TO RELATED APPLICATIONS

This application claims the benefit of U.S. Provisional Patent Application No. 63/444,103, filed Feb. 8, 2023, the entire content of which is herein incorporated by reference.

### STATEMENT REGARDING FEDERALLY SPONSORED RESEARCH OR DEVELOPMENT

(NOT APPLICABLE)

### BACKGROUND

The invention relates to a window assembly for a recreational vehicle (RV) and, more particularly, to an RV window assembly with square corners created from an aluminum extruded frame that acts as the window frame.

FIG. 1 shows a typical RV window W with a plastic or metal frame and including rounded corners RC. The frame with rounded corners is generally easier to manufacture as a one-piece construction or one that is easily assembled using interior tabs inserted into a channel in the ring and secured with a fastener or adhesive. A square window frame in contrast may be preferred aesthetically while also accommodating more window covering options. A square window frame is also easier for the manufacturer to install on the vehicle because of a lack of radiuses or curves to cut in the vehicle wall.

### SUMMARY

A square window frame assembly according to the described embodiments is constructed from four aluminum portions that accommodate a shade assembly, securement of a glass pane, and a hook for installation. The window frame assembly includes frame members that define an interior encasement channel. An encasement may be secured in the encasement channel and may include a shade, or a screen, or both.

In an exemplary embodiment, a window frame assembly includes a top frame member, a bottom frame member, a left side frame member connected between the top and bottom frame members, and a right side frame member connected between the top and bottom frame members. The top, bottom, left side, and right side frame members define a window frame. The left side and right side frame members include an L-shaped bracket that extends outward and away from a forward opening of the window frame, and the top and bottom frame members include an outermost flange that engages the L-shaped bracket such that the outermost flange and the L-shaped bracket define an outboard mounting surface to which a glass pane is securable.

Each of the top, bottom, left side and right side frame members may include a pair of inward-facing planar flanges defining an encasement channel within the window frame. At least one of the top and bottom frame members may include an inward-facing peripheral hook extending along a width of the at least one top and bottom frame member. The top frame member and the bottom frame member may be identical, and the left side frame member and the right side frame member may be identical.

The top and bottom frame members may include from inward to outward a connector panel, an L-shaped extension secured to the connector panel, and the outermost flange secured to the L-shaped extension. The connector panel may include apertures at ends thereof for receiving connectors. The left side and the right side frame members may include from inward to outward an inward-facing planar flange, a primary bracket essentially perpendicular to the inward-facing planar flange, two connector channels coupled with the primary bracket, and the L-shaped bracket connected to the primary bracket. The two connector channels may be oriented essentially perpendicular to each other. The connector panel of the top and bottom frame members may include apertures at ends thereof, where the window frame assembly may further include connectors extending through the apertures into the two connector channels. The top and bottom frame members may further include a forward-facing hook connected to the connector panel.

Each of the top, bottom, left side and right side frame members may include a pair of inward-facing planar flanges defining an encasement channel within the window frame, where the window frame assembly may further include an encasement secured in the encasement channel that has at least one of a shade and a screen. The encasement may include four frame bars each with an inward-facing channel and connecting corner brackets that secure the four frame bars together with the inward-facing channels in alignment to define a continuous channel. The encasement may include a shade assembly secured in the continuous channel adjacent one end of the continuous channel and including the shade, and the encasement may include a screen assembly secured in the continuous channel adjacent an opposite end of the continuous channel and including the screen. One end of the shade may be fixed in the one end of the continuous channel and an opposite end of the shade may be fixed to a shade header, and one end of the screen may be fixed in the opposite end of the continuous channel and an opposite end of the screen may be fixed to a screen header. In this context, the shade header and the screen header may be disposed in the continuous channel in a facing relationship. The shade header and the screen header may each include a proximal connecting portion in which the shade and the screen may be secured, respectively, a distal portion, and a gripping portion disposed between the proximal connecting portion and the distal portion. The distal portions of the shade header and the screen header may include a magnet. A cross section of the shade header and the screen header may include a T-shape and an inverted U-shape, where the inverted U-shape defines the proximal connection portions of the shade header and the screen header.

In another exemplary embodiment, an encasement assembly for a shade and screen includes an encasement including four frame bars each with an inward-facing channel, connecting corner brackets that secure the four frame bars together with the inward-facing channels in alignment to define a continuous channel, a shade assembly secured in the continuous channel adjacent one end of the continuous channel and including the shade, and a screen assembly secured in the continuous channel adjacent an opposite end of the continuous channel and including the screen.

The connecting corner brackets may secure an end of a roller for tensioning either the shade assembly or the screen assembly.

In yet another exemplary embodiment, a square window assembly with an encasement assembly for a shade and a screen includes a top frame member, a bottom frame member, a left side frame member connected between the top and bottom frame members, and a right side frame member connected between the top and bottom frame members. The top, bottom, left side, and right side frame members define a window frame, and each of the top, bottom, left side and right side frame members includes a pair of inward-facing planar flanges defining an encasement channel within the window frame. An encasement secured in the encasement channel includes a shade and a screen, where the shade and the screen are selectively positionable in the encasement channel.

### BRIEF DESCRIPTION OF THE DRAWINGS

These and other aspects and advantages will be described in detail with reference to the accompanying drawings, in which:

FIG. 1 shows a typical RV window including rounded corners;

FIG. 2 shows a square window frame assembly according to the described embodiments;

FIG. 3 is a perspective view showing the top frame member and a side frame member;

FIG. 4 is a perspective view showing the bottom frame member and a side frame member;

FIG. 5 is a sectional view of a side frame member;

FIG. 6 shows a sectional view of the top or bottom frame member;

FIG. 7 shows the interior of the window frame;

FIG. 8 is a side view of the window frame assembly;

FIG. 9 shows an encasement securable in an encasement channel within the window frame;

FIG. 10 shows the encasement with the screen extended;

FIG. 11 shows the encasement with the blind extended;

FIG. 12 shows an exemplary header for the shade or screen;

FIG. 13 shows a cross-sectional view of a header for the shade or screen;

FIG. 14 shows an exemplary embodiment of an encasement including one or more rollers; and FIGS. 15-16 show sectional views of the encasement of FIG. 14.

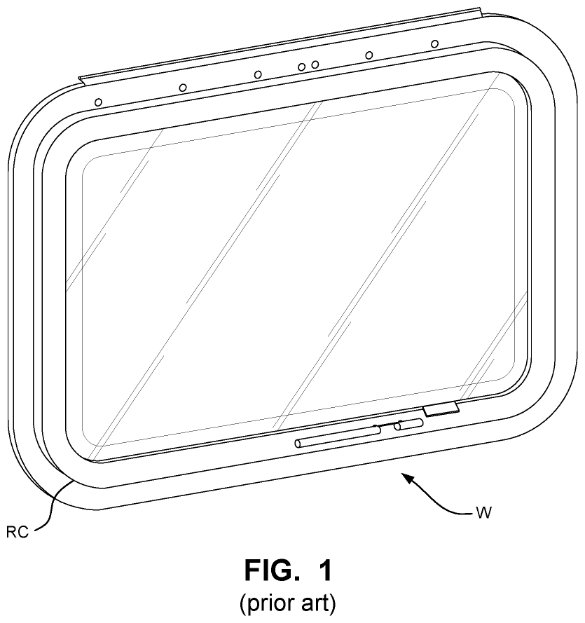

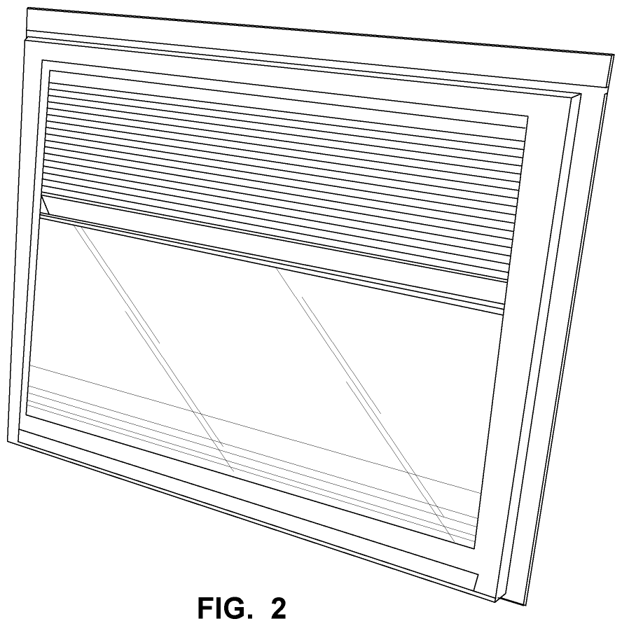

### DETAILED DESCRIPTION

An assembled window frame assembly according to the described embodiments is shown in FIG. 2. With reference to FIGS. 2-4, the window frame assembly 10 includes a top frame member 12, a bottom frame member 14, a left side frame member 16 connected between the top and bottom frame members 12, 14, and a right side frame member 18 connected between the top and bottom frame members 12, 14. The top, bottom, left side, and right side frame members 12, 14, 16, 18 define a window frame.

In some embodiments, as described in more detail below, the top and bottom frame members 12, 14 may be identical and the left side and right side frame members 16, 18 may be identical. When assembled, the top, bottom, left side and right side frame members 12, 14, 16, 18 define a square window frame assembly.

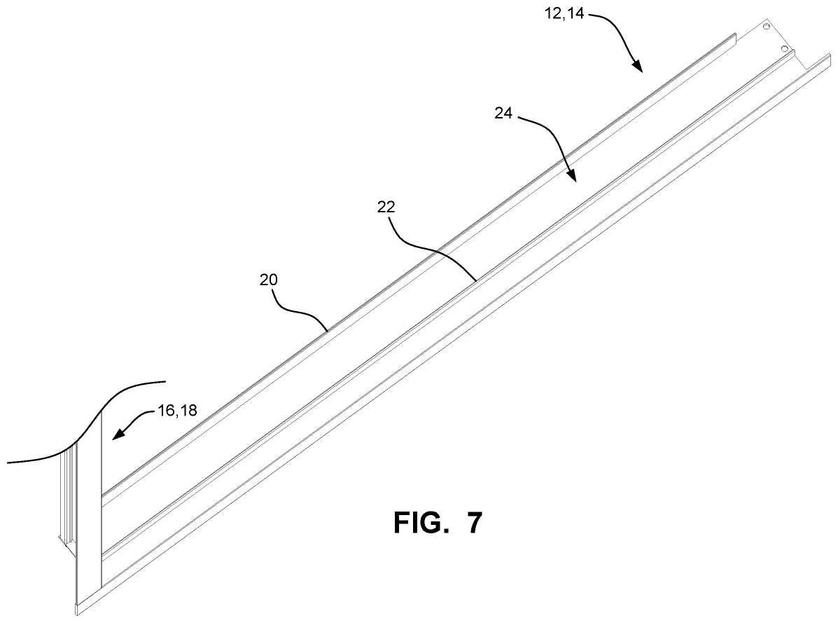

Each of the top, bottom, left side and right side frame members 12, 14, 16, 18 includes an inwardly-facing planar flange 20 that extends into the frame opening and is located at an innermost face of the window frame. A smaller inwardly-facing planar flange 22 is positioned on the opposite side of each frame member 12, 14, 16, 18. The inward-facing planar flanges 20, 22 define an encasement channel 24 within the window frame. See also FIG. 7. A window covering assembly such as the coverings encasement described below may be installed within the encasement channel 24 after the window frame is constructed.

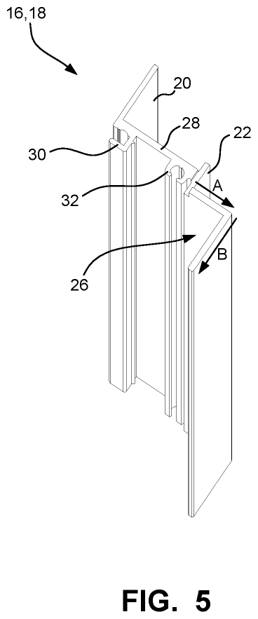

FIG. 5 shows a cross-section of the left and right side frame members 16, 18. The left and right side frame members 16, 18 include an L-shaped bracket 26 that extends outward (arrow A) and away (arrow B) from a forward opening of the window frame. The left and right side frame members 16, 18 also include a primary bracket 28 essentially perpendicular to the inward-facing planar flange 20, a first connector channel 30 coupled with the primary bracket 28 and a second connector channel 32 coupled with the primary bracket 28. The channels 30, 32 may span the length of the left and right side frame members 16, 18. The channels 30, 32 may serve for securing shims, which are well-known in the field for centering a window frame in a rough opening of the vehicle wall. The two connector channels 30, 32 are oriented essentially perpendicular to each other. That is, the first channel 30 is essentially parallel with the primary bracket 28 and is closer to the outer face of the window frame, while the second channel 32 has an opening facing outboard to the frame. Although not shown in the drawings, the top and bottom frame members 12, 14 may similarly include channels or flanges integrated into inboard and outboard sides to accommodate a shim.

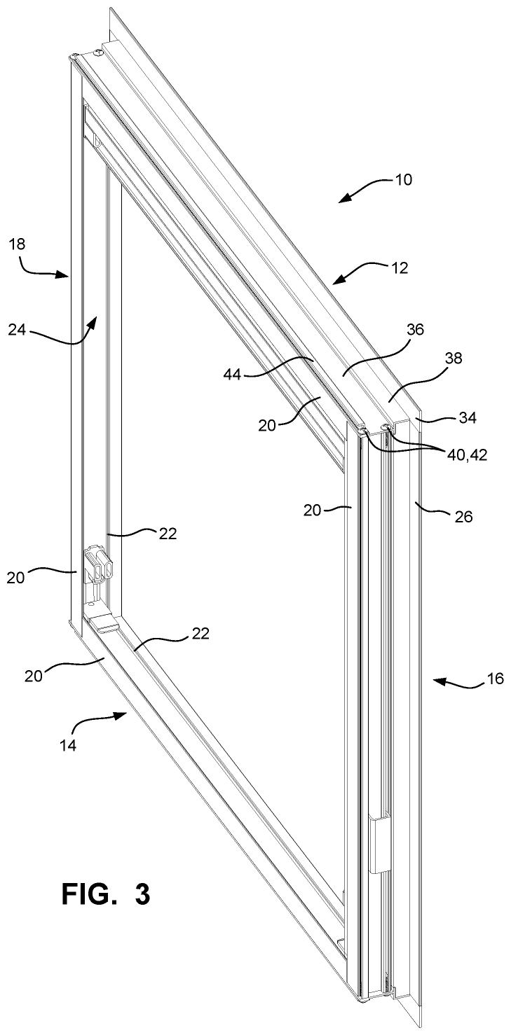

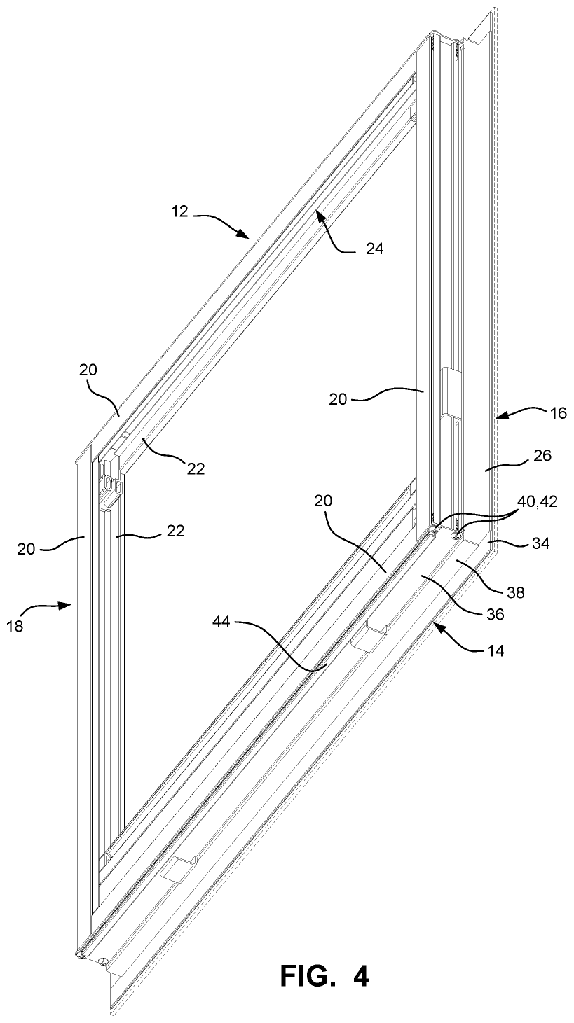

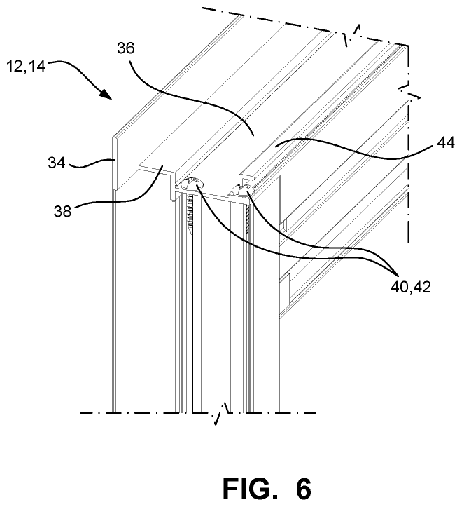

With reference to FIGS. 3 and 6, the top and bottom frame members 12, 14 include an outermost flange 34 that engages the L-shaped bracket 26 of the left and right side frame members 16, 18. As shown in FIGS. 3 and 4, the outermost flange 34 and the L-shaped bracket 26 define an outboard mounting surface to which a glass pane is securable via an adhesive or the like.

FIG. 6 shows a cross-section of the top and bottom frame members 12, 14. The top and bottom frame members 12, 14 include a connector panel 36, an L-shaped extension 38 secured to the connector panel 36, and the outermost flange 34 secured to the L-shaped extension 38. The connector panel 36 includes apertures 40 at ends thereof for receiving connectors 42. The connectors 42 extend through the apertures 40 into the connector channels 30, 32 of the left and right side frame members 16, 18. At least one of the top and bottom frame members 12, 14 also includes an inward-facing peripheral hook 44 extending along a width of the top and/or bottom frame member 12, 14.

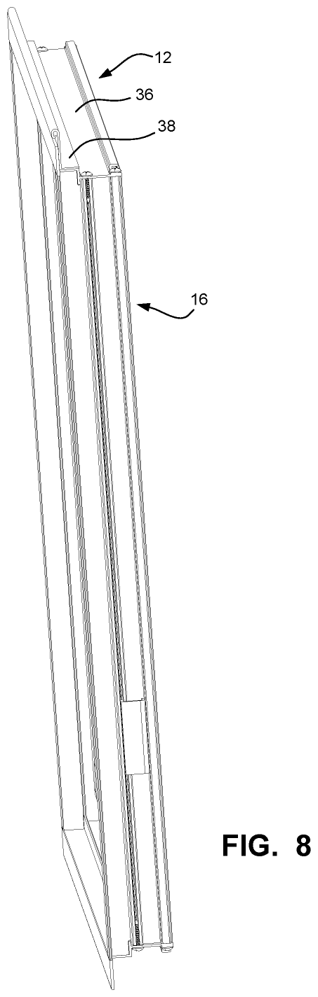

With reference to FIG. 8, the top frame member 12 is shown with a forward-facing hook 46 connected to the connector panel 36 or the L-shaped extension 38. A similar peripheral hook may be provided on the bottom frame member 14. The peripheral hooks 46 may be used for securing a trim ring.

The encasement channel 24 is sized and configured to secure a covering encasement that has at least one of a shade system and a screen system. In some embodiments, the covering encasement includes both the shade system and the screen system.

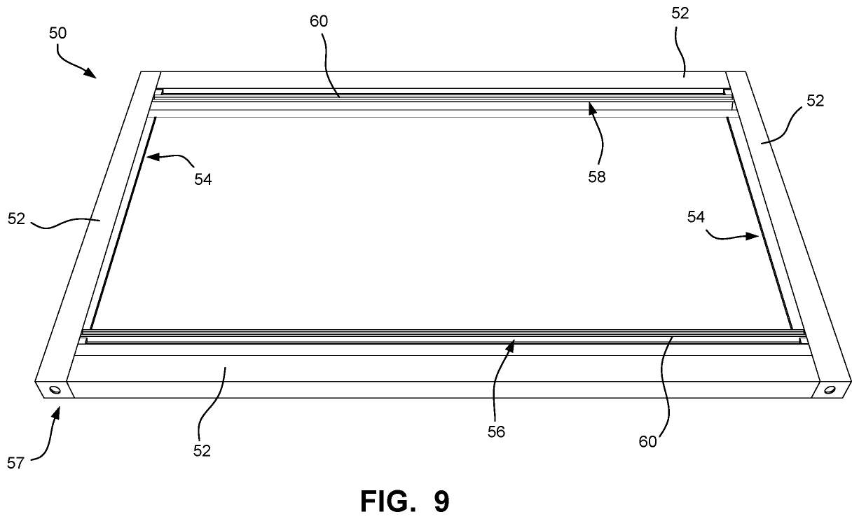

FIG. 9 shows the covering encasement 50 that is sized to fit in the encasement channel 24. It will be appreciated that the covering encasement 50 could be utilized in other window frames or assemblies. In an exemplary construction, one of the coverings is movable in a top-down manner in the covering encasement 50, and the other of the coverings is movable in a bottom-up manner in the covering encasement 50. Each covering includes respective header assemblies that are secured at one of the top or bottom of the encasement. With the described construction, the two separate headers are capable of abutting to have a user-selected extension of either the shade or screen or both deployed at the same time.

The encasement 50 includes four frame bars 52 each with an inward-facing channel 54 and connecting corner brackets 57 that secure the four frame bars 52 together. With the four frame bars 52 assembled as shown in FIG. 9, the inward-facing channels 54 align to define a continuous channel. In some embodiments, the encasement 50 is press fit into the encasement channel 24 of the window frame. Alternatively, the encasement 50 can be secured with fasteners.

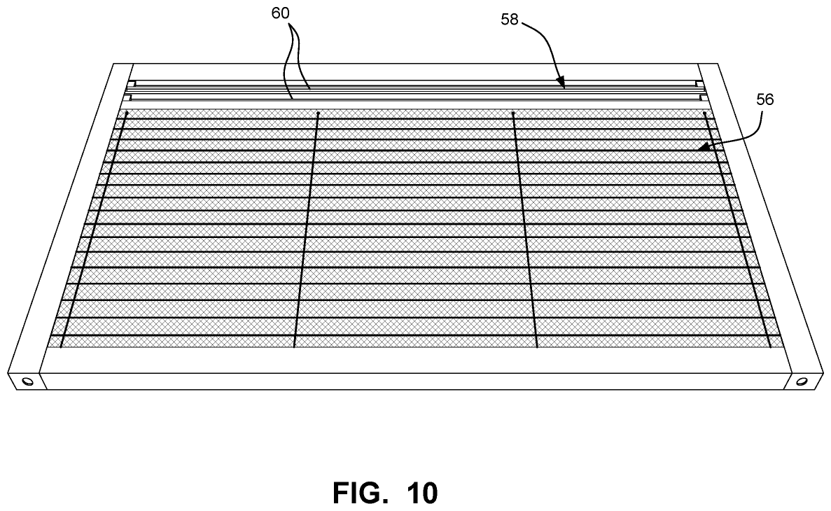

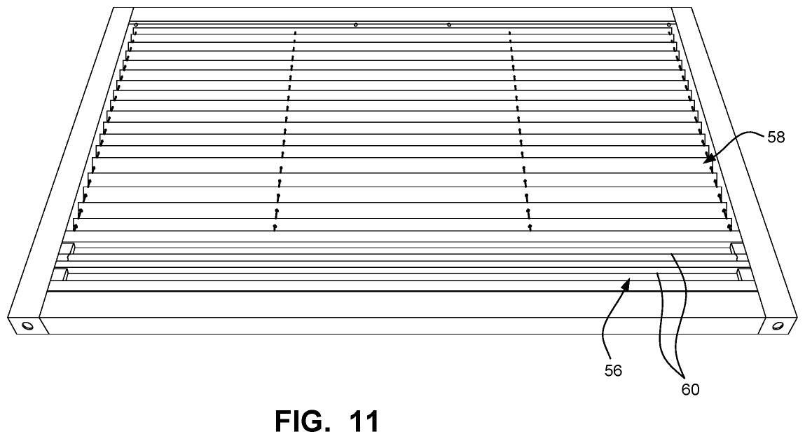

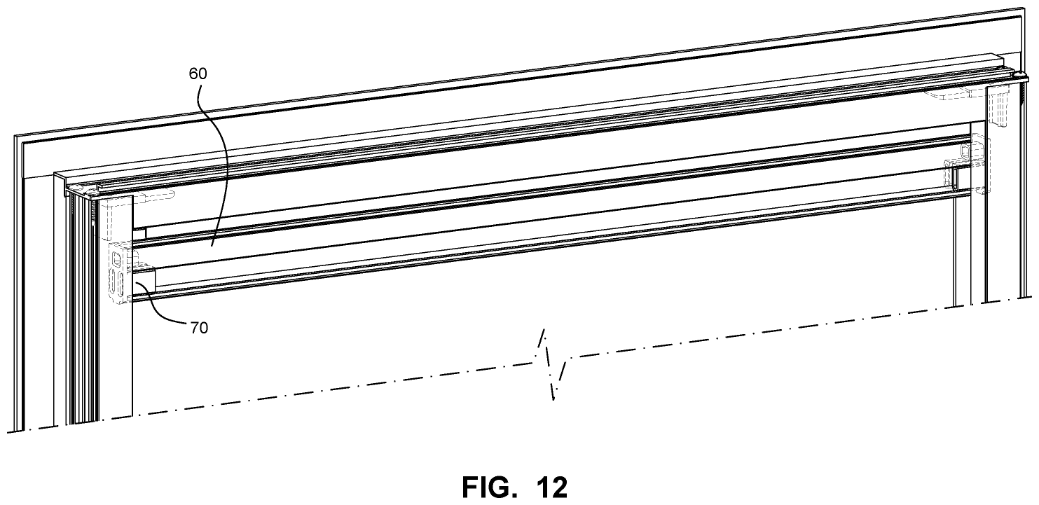

With reference to FIGS. 9-11, a screen assembly 56 is secured at one end of the continuous channel, and a shade assembly 58 is secured at an opposite end of the continuous channel. The screen assembly may include mesh or any other suitable material for allowing air passage while preventing bugs or outdoor elements from entering. The shade assembly may be any suitable blinds assembly including but not limited to venetian, folding, pleated, or roller blinds. A proximal or fixed end of each of the coverings may be secured to one of the frame bars with corresponding fasteners or may be secured with an adhesive or other suitable method. In some embodiments, the non-header end of the coverings may extend through a slot in either the top or bottom of the encasement frame and includes an adhesive or some kind of integral bead or stopper to prevent the covering from exiting the slot. The distal end of each covering includes a header 60. A tensioned cable, cord or string may be looped through the top and bottom of the encasement 50 in the side component channels to tension and hold the headers 60 in a user-selected position. Alternatively or additionally, the encasement channel 54 may be specially shaped to accommodate the headers 60 so that the headers 60 are held in a friction-fit.

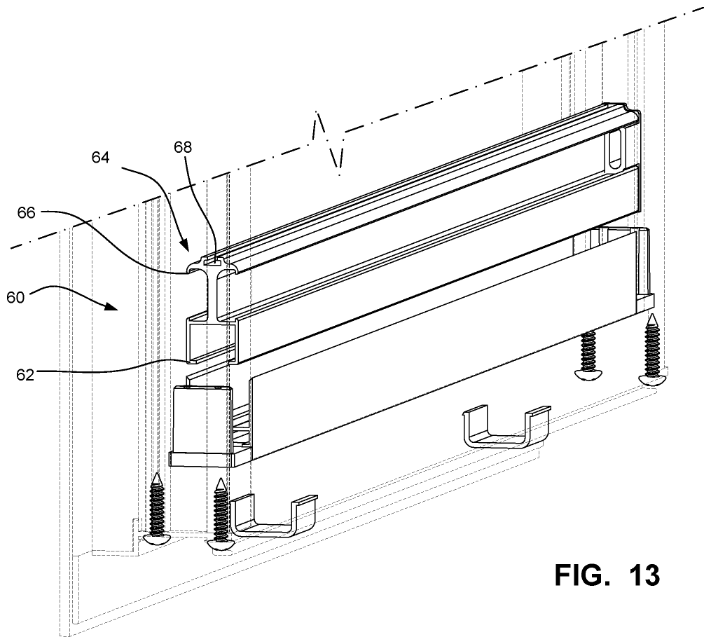

FIGS. 12 and 13 show the headers 60 secured in the continuous channel defined by the continuous inward-facing channels 54. The headers 60 are disposed in the continuous channel in a facing relationship. With particular reference to FIG. 13, the headers 60 each include a proximal connecting portion 62 in which the shade and the screen are secured, respectively, a distal portion 64, and a gripping portion 66 disposed between the proximal connecting portion 62 and the distal portion 64. The distal portion 64 may be rounded or protruding and may include a magnet 68 for contact and connection with the opposing header 60. The gripping portion 66 creates a valley between proximal and distal ends of the header 60 to create the gripping portion for the user. With continued reference to FIG. 13, a cross-section of the header 60 may have a T-shape with an inverted U-shape connected to the bottom. The head of the T-shape may include a channel to receive the magnet 68. The body of the T-shape creates the gripping portion 66 for the user. The inverted U-shape may secure the traveling end of the shade or screen with a retaining element that slidingly fits inside prior to installation. That is, the inverted U-shape defines the proximal connection portions of the shade header and the screen header.

The header cross-sectional shape may also accommodate plastic end caps 70 (FIG. 12) that press fit with the header 60 to assist in the sliding motion of the header 60 within the encasement channel. The end caps 70 may include an aperture for a guide cord to run through the header 60 to further connect the header assembly to either the top or bottom of the encasement.

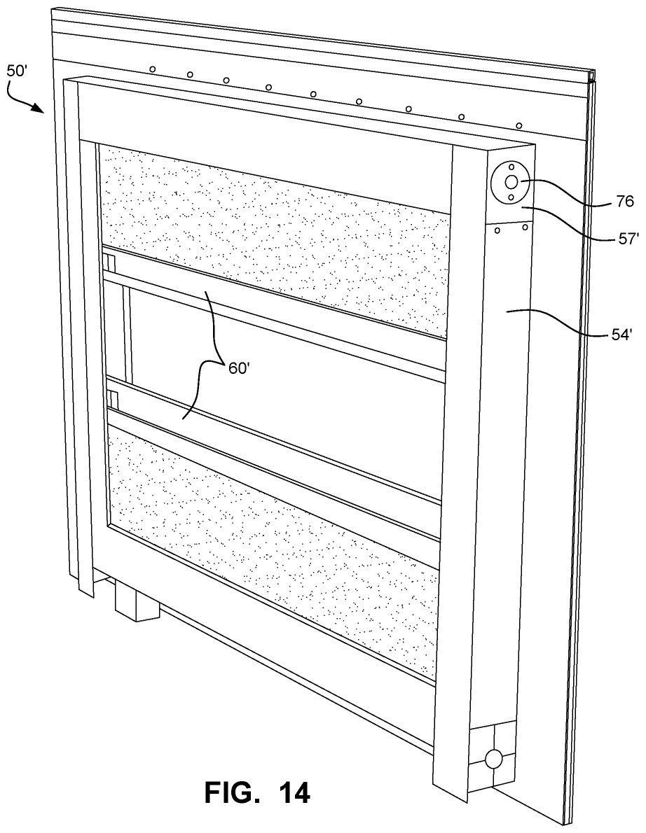

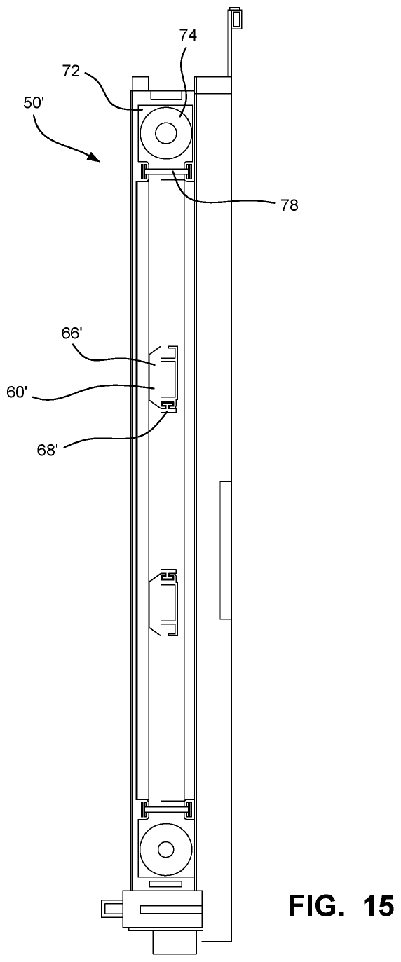

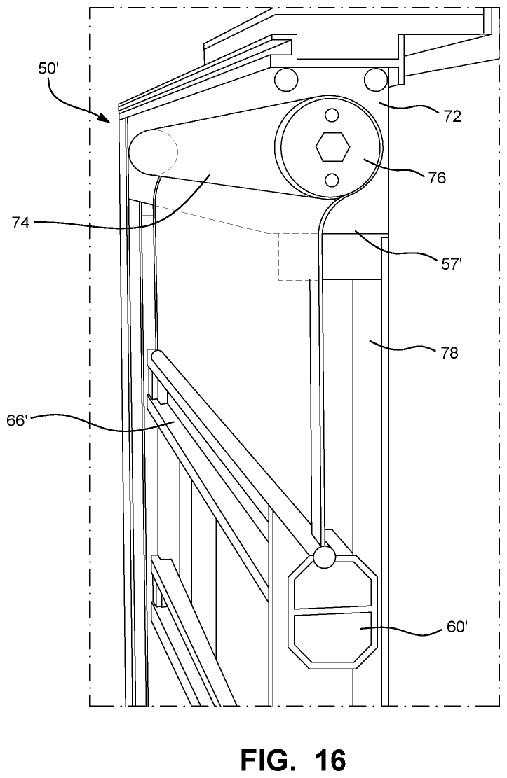

FIGS. 14-16 show an alternative embodiment of the encasement 50′ including at least one roller assembly 72. The roller assembly 72 may include a self-tensioning roller 74 that provides constant tension to extend and retract either a shade or screen assembly. The embodiment shown includes roller assemblies 72 in both the top and bottom of the encasement 50′. A user actuates the shade or screen assembly using a header 60′ with a gripping portion 66′ while the shade or screen furls or unfurls from the roller 74. Connecting corner brackets 57′ may include a molded end cap 76 that secures an end of the roller 74 proximate a corner of the encasement channel 54′. When the headers 60′ are connected by a magnet 68′, the user can adjust the position of the headers to create infinite shade or screen settings, similar to the embodiments described above. Weatherproofing pile 78 may be installed around the perimeter of the encasement 50′ or near the roller assembly 72 to help clean the shade or screen of dust or debris and prevent outdoor elements from entering the encasement channel 54′.

The square window assembly of the described embodiments is constructed from four aluminum portions that accommodate a shade assembly, securement of a glass pane, and a hook for installation. The square window frame accommodates more window covering options and is easier to install without requiring radiuses or curves to be cut in the vehicle wall. The assembly also accommodates a covering encasement enabling selective positioning of a shade and/or screen.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A window frame assembly comprising:
a top frame member;
a bottom frame member;
a left side frame member connected between the top and bottom frame members; and
a right side frame member connected between the top and bottom frame members, wherein the top, bottom, left side, and right side frame members define a window frame,
wherein the left side and right side frame members include an L-shaped bracket that extends outward and away from a forward opening of the window frame, and wherein the top and bottom frame members include an outermost flange that engages the L-shaped bracket such that the outermost flange and the L-shaped bracket define an outboard mounting surface to which a glass pane is securable.

2. A window frame assembly according to claim 1, wherein each of the top, bottom, left side and right side frame members comprises a pair of inward-facing planar flanges defining an encasement channel within the window frame.

3. A window frame assembly according to claim 1, wherein at least one of the top and bottom frame members comprises an inward-facing peripheral hook extending along a width of the at least one top and bottom frame member.

4. A window frame assembly according to claim 1, wherein the top frame member and the bottom frame member are identical, and wherein the left side frame member and the right side frame member are identical.

5. A window frame assembly according to claim 1, wherein the top and bottom frame members comprise from inward to outward a connector panel, an L-shaped extension secured to the connector panel, and the outermost flange secured to the L-shaped extension.

6. A window frame assembly according to claim 5, wherein the connector panel comprises apertures at ends thereof for receiving connectors.

7. A window frame assembly according to claim 5, wherein the left side and the right side frame members comprise from inward to outward an inward-facing planar flange, a primary bracket essentially perpendicular to the inward-facing planar flange, two connector channels coupled with the primary bracket, and the L-shaped bracket connected to the primary bracket.

8. A window frame assembly according to claim 7, wherein the two connector channels are oriented essentially perpendicular to each other.

9. A window frame assembly according to claim 7, wherein the connector panel of the top and bottom frame members comprises apertures at ends thereof, the window frame assembly further comprising connectors extending through the apertures into the two connector channels.

10. A window frame assembly according to claim 5, wherein the top and bottom frame members further comprise a forward-facing hook connected to the connector panel.

11. A window frame assembly according to claim 1, wherein each of the top, bottom, left side and right side frame members comprises a pair of inward-facing planar flanges defining an encasement channel within the window frame, the window frame assembly further comprising an encasement secured in the encasement channel, the encasement including at least one of a shade and a screen.

12. A window frame assembly according to claim 11, wherein the encasement comprises four frame bars each with an inward-facing channel and connecting corner brackets that secure the four frame bars together with the inward-facing channels in alignment to define a continuous channel.

13. A window frame assembly according to claim 12, wherein the encasement comprises a shade assembly secured in the continuous channel adjacent one end of the continuous channel and including the shade, and wherein the encasement comprises a screen assembly secured in the continuous channel adjacent an opposite end of the continuous channel and including the screen.

14. A window frame assembly according to claim 13, wherein one end of the shade is fixed in the one end of the continuous channel and an opposite end of the shade is fixed to a shade header, and wherein one end of the screen is fixed in the opposite end of the continuous channel and an opposite end of the screen is fixed to a screen header, the shade header and the screen header being disposed in the continuous channel in a facing relationship.

15. A window frame assembly according to claim 14, wherein the shade header and the screen header each comprises a proximal connecting portion in which the shade and the screen are secured, respectively, a distal portion, and a gripping portion disposed between the proximal connecting portion and the distal portion.

16. A window frame assembly according to claim 15, wherein the distal portions of the shade header and the screen header comprise a magnet.

17. A window frame assembly according to claim 16, wherein a cross section of the shade header and the screen header comprises a T-shape and an inverted U-shape, the inverted U-shape defining the proximal connection portions of the shade header and the screen header.

18. An encasement assembly for a shade and screen, the encasement assembly comprising:
an encasement including four frame bars each with an inward-facing channel;
connecting corner brackets that secure the four frame bars together with the inward-facing channels in alignment to define a continuous channel;
a shade assembly secured in the continuous channel adjacent one end of the continuous channel and including the shade; and
a screen assembly secured in the continuous channel adjacent an opposite end of the continuous channel and including the screen.

19. An encasement assembly according to claim 18, wherein one end of the shade is fixed in the one end of the continuous channel and an opposite end of the shade is fixed to a shade header, and wherein one end of the screen is fixed in the opposite end of the continuous channel and an opposite end of the screen is fixed to a screen header, the shade header and the screen header being disposed in the continuous channel in a facing relationship.

20. A window frame assembly according to claim 19, wherein the shade header and the screen header each comprises a proximal connecting portion in which the shade and the screen are secured, respectively, a distal portion, and a gripping portion disposed between the proximal connecting portion and the distal portion.

21. A window frame assembly according to claim 20, wherein the distal portions of the shade header and the screen header comprise a magnet.

22. A window frame assembly according to claim 21, wherein a cross section of the shade header and the screen header comprises a T-shape and an inverted U-shape, the inverted U-shape defining the proximal connection portions of the shade header and the screen header.

23. A window frame assembly according to claim 18, wherein the connecting corner brackets secure an end of a roller for tensioning either the shade assembly or the screen assembly.

24. A square window assembly including an encasement assembly for a shade and a screen, the square window assembly comprising:
a top frame member;
a bottom frame member;
a left side frame member connected between the top and bottom frame members;
a right side frame member connected between the top and bottom frame members, wherein the top, bottom, left side, and right side frame members define a window frame, and wherein each of the top, bottom, left side and right side frame members comprises a pair of inward-facing planar flanges defining an encasement channel within the window frame; and
an encasement secured in the encasement channel and including a shade and a screen, wherein the shade and the screen are selectively positionable in the encasement channel.
